(19) United States
(12) Patent Application Publication
(10) Pub. No.: US 2009/0282276 A1
(43) Pub. Date: Nov. 12, 2009

(54) Peripheral device

(76) Inventors: Iain Thomas Learmonth, Basingstoke (GB); Musa Ibrahim Kakish, Anaheim, CA (US)

Correspondence Address: LAMBERT & ASSOCIATES, P.L.L.C., 92 STATE STREET, BOSTON, MA, 02109-2004, US

(21) Appl. No.: 12/387,916

(22) Filed: May 8, 2009

Related U.S. Application Data
(60) Provisional application No. 61/127,180, filed on May 12, 2008.

(51) Int. Cl. G06F 1/00

(52) U.S. Cl. 713/320

(57) ABSTRACT

A peripheral device for a host computer comprises:
means for physical connection of the device for its powering by and communication with the host computer;
a manual switch on the device for powering down and up of the device; and
circuitry in the device enabling it to perform a function of the device, the circuitry being connected to the computer via the physical connection when in use and to the manual switch for communicating to the host computer in response to actuation of the switch:
   a first signal when the device is powered up for initiating in the host computer a hardware-removal routine causing the peripheral to draw substantially less than normal or no power and
   a second signal when powered down to cause the host computer to initiate a peripheral-detection-and-power-up routine.

### CROSS REFERENCE TO RELATED APPLICATION

This application takes priority from and claims the benefit of Provisional Application Ser. No. 61/127,180 filed on May 12, 2008 the contents of which are hereby incorporated by reference.

### BACKGROUND OF THE INVENTION

1. Field of the Invention

The present invention relates to a peripheral device adapted to be powered by a host computer.

2. Description of the Related Art

Lap top computers, also known as “notebook” computers, have a limited battery life at least partially because of the power consumption of the display, but also because the main processor chip consumes an appreciable current. Their convenience in use is being enhanced substantially by their ability to communicate wirelessly with peripherals such as printers—as by the wireless USB protocol, known as Certified Wireless USB. Existing laptops, not having CWUSB capability built in can be retro-fitted with the capability by means of a card in accordance with the ExpressCard standard of the Personal Computer Memory Card International Association—referred to herein as an Express card. A disadvantage of CWUSB is that it is an ultra-wide band protocol and as such its power consumption is high.

It is possible to remove physically an Express card after each printing operation, to conserve power, but this is generally inconvenient and bad practice without following the time consuming “Safely Remove Hardware” routine. Another alternative is for the computer to be left to power down the card after lack of use has been detected for a period of time. Nevertheless, a significant reduction in battery life occurs before the CWUSB Express card is powered down.

### SUMMARY OF THE INVENTION

The object of the present invention is to provide a CWUSB Express card or other peripheral device powered by and therefore consuming laptop battery power which can be manually switched off when no longer required.

According to the invention there is provided a peripheral device for a host computer, the device comprising:
means for physical connection of the device for its powering by and communication with the host computer;
a manual switch on the device for powering down and up of the device; and
circuitry in the device enabling it to perform a function of the device, the circuitry being connected to the computer via the physical connection when in use and to the manual switch for communicating to the host computer in response to actuation of the switch:
   a first signal when the device is powered up for initiating in the host computer a hardware-removal routine causing the peripheral to draw substantially less than normal or no power and
   a second signal when powered down to cause the host computer to initiate a peripheral-detection-and-power-up routine.

As used herein, “power down” means set to a state using substantially less or no power. Further, by physical connection is meant conductor/conductor connection, which will usually be disconnectable. It is envisaged that the peripheral device may be plugged into the host computer as via a dedicated card slot or via a USB port and receiving its power via the relevant power terminals in either case. Alternatively the device may be connected to the computer via a USB cable and receiving its power via this.

In the case of an Express card for CWUSB connection, the card will have an ASIC processor, which can be programmed to send the first signal to the host computer on one of its USB data lines. In response, the computer by operation of its hardware-removal routine, commands the card via the USB lines to power down, i.e. cease to draw power other than on the stand by auxiliary voltage power supply line.

For generation of the second signal, the card is provided with a dedicated power-up-signal generating device operable by the auxiliary voltage power supply line. It outputs a signal on the line normally transmitting a card present signal to the host computer.

In the case of a CWUSB dongle plugged directly into a USB socket on the host computer, again its ASIC is programmed to send the first or power-down request signal for the host's software to detect on actuation of the switch, via its data lines. For sending its second or power-up request signal, button operation will cause the dongle's “device present” resistor to be open circuited for a length of time sufficient for the host to cease to recognise the dongle as present and then to be reconnected for the host to recognise its presence and cause it to be powered up.

In the case of a cable connected CWUSB device, it is set up in the same manner as the dongle and the relevant signals are transmitted as if it were directly connected to the host device.

The peripheral device could be another type of wireless device, for instance a wireless network card, mobile telephone card or the like, any of which the user of the host computer may wish to disable to prolong the battery life of his computer.

### BRIEF DESCRIPTION OF THE DRAWINGS

To help understanding of the invention, a specific embodiment thereof will now be described by way of example and with reference to the accompanying drawings, in which:

FIG. 1 is a diagrammatic view of a host computer equipped with a peripheral device in the form of a CWUSB Express card and FIG. 2 is a partial circuitry diagram of the CWUSB Express card of FIG. 1.

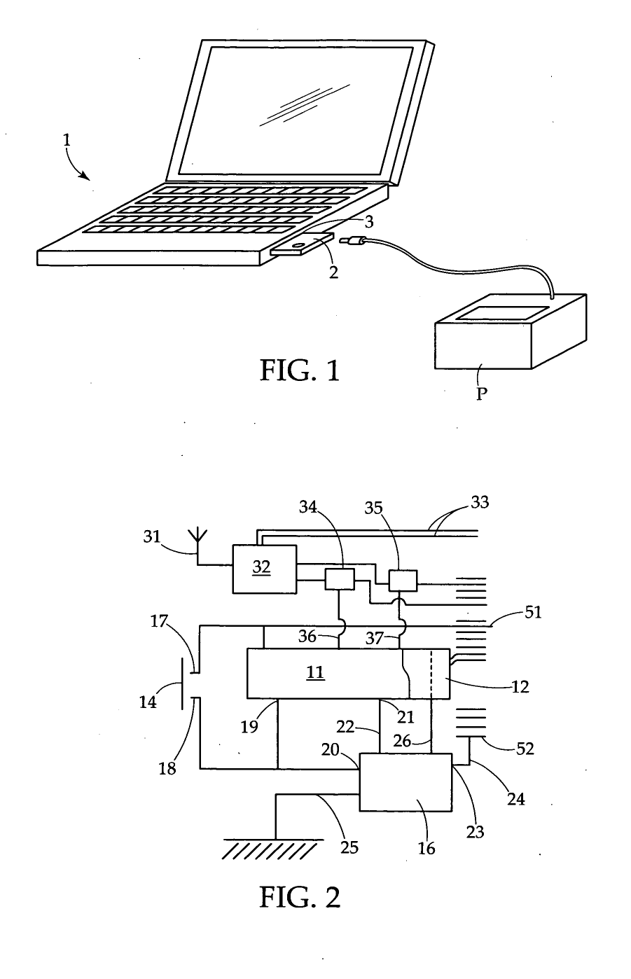

### DETAILED DESCRIPTION OF THE PREFERRED EMBODIMENT

Referring to the drawings, a host laptop computer 1 has a peripheral CWUSB Express card 2 plugged into a socket 3, where internal contact is made in accordance with the ExpressCard standard. Amongst the contacts are the following:
two USB data lines;
primary voltage at +3.3V;
secondary voltage at +1.5V;
auxiliary voltage at +3.3V−Vaux−51;
ground;
card present contact−CPC−52.
   Two additional sets of databus lines are provided.

Amongst the circuitry on the card is an ASIC 11 including a USBphi circuit 12, a manual switch 14, and an monostable circuit 16, these being connected as shown in FIG. 2, which also shows connections to certain of the card's contacts mentioned in the previous paragraph.

The manual switch is normally open, having the Vaux line connected to one terminal 17 and having its other terminal 18 connected to an input 19 to the ASIC and an input 20 to the monostable circuit 16. An output 21 of the ASIC is connected on line 22 to an “enable” input of the monostable. The latter has an output 23 connected on line 24 to the card present contact. The output 23 is normally grounded, via the monostable circuit and the line 25 to the card's ground. The monostable is also powered from the Vaux line 51 on line 26. When the monostable is enabled by the ASIC, via application of Vaux on line 22, and the button is pressed, Vaux is applied also to the input 20. The monostable circuit then opens the connection between ground and the CPC contact 52 for a period, typically 5 seconds.

As conventionally, the host computer is adapted to detect presence of a card in the socket 3 by means of its contact complementary to the CPC contact being grounded. When the monostable is cycled, removal of the card from the host and its re-insertion is simulated so far as the host's circuitry is concerned.

The host computer is provided with software complementary to the card 2, enabling it to react to a specific signal on the USB data lines resulting from making of the manual switch 14.

Operation of the card as regards the switch will now be described—its CWUSB operation is by means of an antenna 31 and a transceiver 32, the latter being connected to data-lines 34,35 and primary and secondary voltage power switches 34, 35. These are controlled by the ASIC via GPIO pins 36, 37.

On first insertion of the card into the computer, the monostable may remain in its quiescent state with the CPC line grounded or it may cycle to this state. The computer detects presence of the card and signals it to power up and enumerates it.

It can be used for instance for sending a document to a printer P. Once its use has finished, its button is pushed to power it down. The monostable is not enabled by the ASIC, which does this only when it is in its powered down state. The button press signal is also passed to the ASIC via its input 19. This causes the ASIC to send to the computer on the USB lines a signal recognisable by the complementary software. This causes the computer to send the power down signals to the card that it would send if the computer's “safely remove hardware” routine were followed. This signal causes the ASIC to remove voltage from the switches 34, 35, whereby the transceiver circuit is switched off and ceases to consume power.

Should the user require to print another document, he or she presses the button again. This time, although the ASIC is powered down, it nevertheless enables the monostable during the time when its powered down, in readiness for a power up button signal. The button press causes the monostable to cycle, removing and re-establishing the grounding of the CPC line. The computer reacts as if the card had been inserted in the first place. The card is powered up and enumerated as if it had been re-inserted. The transceiver is switched on once more and the card can then be used of printing.

The invention is not intended to be restricted to the details of the above described embodiment. For instance, in place of the monostable being enabled by Vaux voltage on the line 22 when powered down, it could be disabled by application of primary voltage on this line when the ASIC is powered up and enabled by absence of such an inhibiting voltage when the ASIC is powered down.

1. A peripheral device for a host computer, the device comprising:
means for physical connection of the device for its powering by and communication with the host computer;
a manual switch on the device for powering down and up of the device; and
circuitry in the device enabling it to perform a function of the device, the circuitry being connected to the computer via the physical connection when in use and to the manual switch for communicating to the host computer in response to actuation of the switch:
a first signal when the device is powered up for initiating in the host computer a hardware-removal routine causing the peripheral to draw substantially less than normal or no power and
a second signal when powered down to cause the host computer to initiate a peripheral-detection-and-power-up routine.

2. A peripheral device according to claim 1, wherein the means for physical connection is USB connector.

3. A peripheral device according to claim 1, wherein the means for physical connection is a PCMCIA connector.

4. A peripheral device according to claim 3, wherein the peripheral device is configured as Express card for CWUSB connection and includes:
functional circuitry for performing the function of the device,
power switches between primary and secondary voltage contacts in the PCMCIA connector and the functional circuitry and
an ASIC processor programmed (i.) to send the said first signal to the host computer on one of its USB data lines, (ii.) to open the power switches on receipt of a signal from the host computer on running of its hardware-removal routine and (iii.) to close the power switches on receipt of the said second signal or a peripheral-detection-and-power-up signal from the computer, the ASIC sending and receiving signals via the USB lines.

5. A peripheral device according to claim 3, wherein the circuitry includes a power-up-signal generating device operable by auxiliary voltage in response to actuation of the manual switch and connected to a card present contact in the connector.

6. A peripheral device according to claim 2, wherein the peripheral device is a USB device including an ASIC programmed to send the said first signal for the host's software to detect on actuation of the manual switch, via its data lines.

7. A peripheral device according to claim 2, including a device-present resistor, with the manual switch being arranged to disconnect resistor for a discrete period of time only, sufficient for the host computer to cease to recognise the device as present and then recognise its presence again at the end of the period for powering up.

8. A peripheral device according to claim 1, wherein the device is chosen from the group comprising a wireless network card and a mobile telephone card.

9. A peripheral device according to claim 1, wherein the device is connected to a host computer and the host computer is programmed with a software for recognising the said first signal for initiating in the host computer a hardware-removal routine.
